(19) United States
(12) Patent Application Publication
(10) Pub. No.: US 2018/0193897 A1
(43) Pub. Date: Jul. 12, 2018

(54) PORTABLE HOSE FITTING SWAGING DEVICE

(71) Applicant: UEMSI/HTV, Inc., Menomonee Falls, WI (US)

(72) Inventors: Richard D. Dresang, Menomonee Falls, WI (US); Daniel M. Olson, Menomonee Falls, WI (US); Bernard M. Hengels, Menomonee Falls, WI (US); Kevin J. Witt, Menomonee Falls, WI (US); Jack V. Roberts, Menomonee Falls, WI (US); Charles S. Duginski, Menomonee Falls, WI (US); Brian Robert Blake, Cadillac, MI (US); Dean Robert Rohn, Cadillac, MI (US); Robert H. Glick, Cadillac, MI (US); Chad P. Brunink, Cadillac, MI (US)

(21) Appl. No.: 15/405,225

(22) Filed: Jan. 12, 2017

(51) Int. Cl. B21D 39/04; B25B 27/02; B25B 27/10

(52) U.S. Cl. CPC B21D 39/046; B25B 27/10; B25B 27/026

(57) ABSTRACT

A hose fitting swaging device may include a base at least two truss rods, first and second die collars and a hydraulic cylinder. The truss rods may be spaced apart from each other and extend upward from the base. Each truss rod may have a proximal end removably secured to the base. Each truss rod may also have a distal end opposite the base. The first die collar may be removably secured to the distal ends of the truss rods. The second die collar may be slideably retained by the truss rods, between the base and the first die collar. The hydraulic cylinder may be removably secured to the base in between the truss rods and beneath the second die collar. Thus, the hydraulic cylinder may be operable to forcibly drive the second die collar upwards, along the truss rods, toward the first die collar. The first die collar may be supported entirely by the truss rods.

### BACKGROUND

The present disclosure relates generally to hose fitting swaging devices. In particular, portable hose fitting swaging devices are described.

Known hose fitting swaging devices are not entirely satisfactory for the range of applications in which they are employed. For example, existing hose fitting swaging devices may be too heavy to be portable enough to allow in-the-field hose repair. Furthermore, conventional hose fitting swaging devices may bend and bind under the strain required for swaging larger diameter hose fittings. Finally, existing hose fitting swaging devices may not be fully disassembled and repaired in the field.

Thus, there exists a need for hose fitting swaging devices that improve upon and advance the design of known such devices. Examples of new and useful hose fitting swaging devices relevant to the needs existing in the field are discussed below.

### SUMMARY

A hose fitting swaging device may include a base at least two truss rods, first and second die collars and a hydraulic cylinder. The truss rods may be spaced apart from each other and extend upward from the base. Each truss rod may have a proximal end removably secured to the base. Each truss rod may also have a distal end opposite the base. The first die collar may be removably secured to the distal ends of the truss rods. The second die collar may be slideably retained by the truss rods, between the base and the first die collar. The hydraulic cylinder may be removably secured to the base in between the truss rods and beneath the second die collar. Thus, the hydraulic cylinder may be operable to forcibly drive the second die collar upwards, along the truss rods, toward the first die collar. The first die collar may be supported entirely by the truss rods.

### BRIEF DESCRIPTION OF THE DRAWINGS

FIG. 1 is a perspective view of first example of a portable hose fitting swaging device.

FIG. 2 is an exploded view of the hose fitting swaging device of FIG. 1.

FIG. 3 is a perspective view of a hose fitting swaging device including swaging dies as well as a hose and a hose fitting.

FIG. 4 is a perspective view of a die collar of a hose fitting swaging device holding a two-part swaging die.

### DETAILED DESCRIPTION

The disclosed hose fitting swaging devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various hose fitting swaging devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

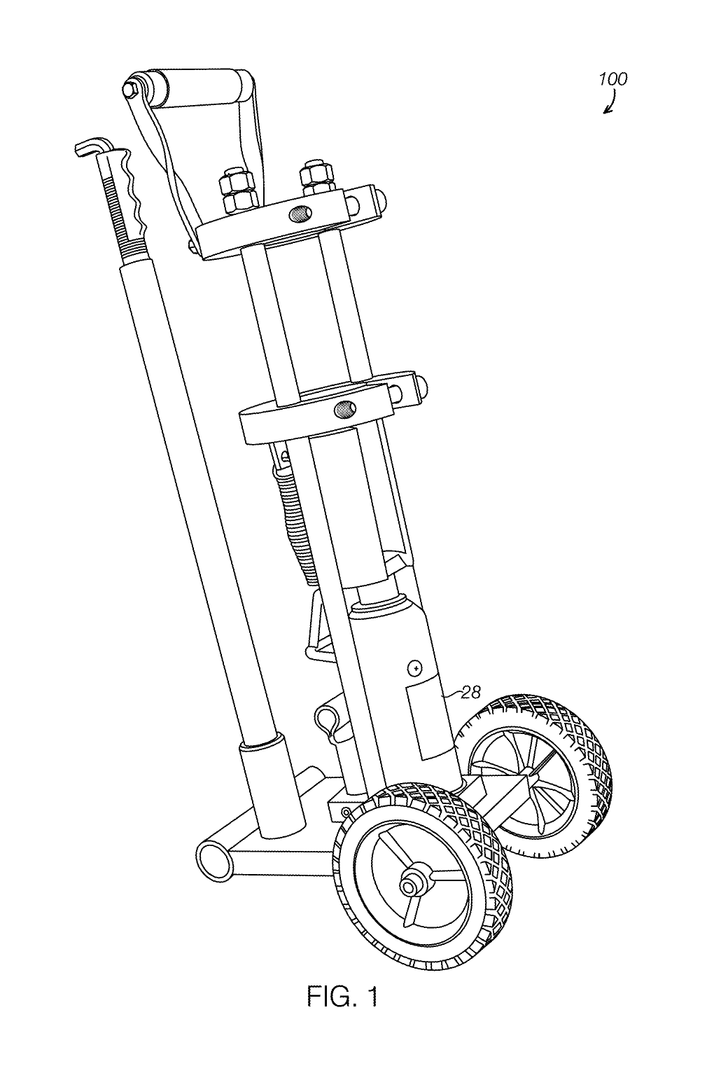

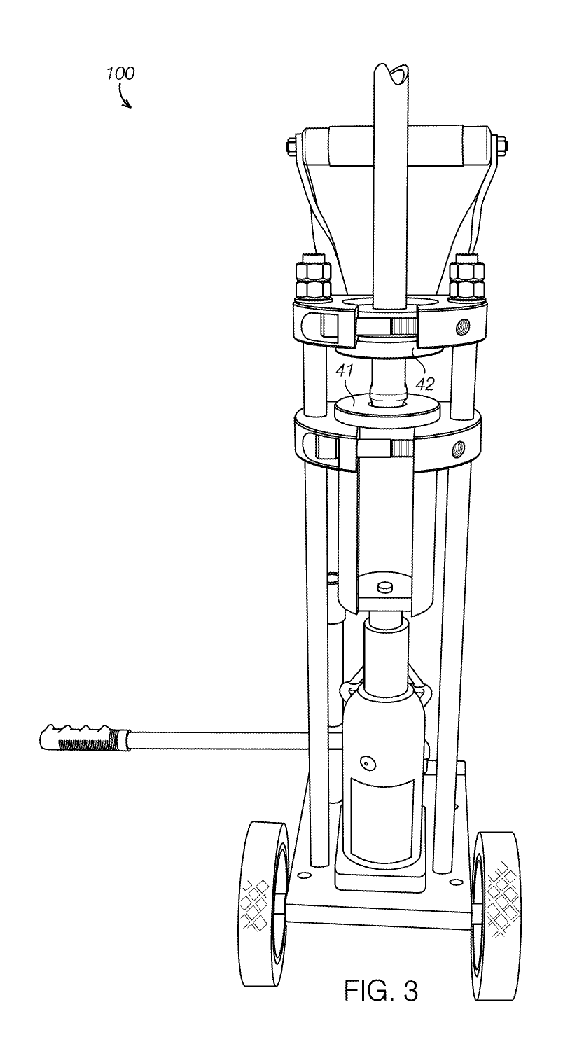

With reference to FIGS. 1-4, a first example of a portable hose fitting swaging device, device 100, will now be described. Device 100 functions to quickly and easily secure hose fittings to hose ends. The reader will appreciate from the figures and description below that device 100 addresses shortcomings of conventional hose fitting swaging devices.

For example, device 100 is able to be transported into the field to make repairs onsite. This is due, at least in part, to device 100 being hand operable rather than motor driven. Further, device 100 is rigid enough to allow swaging of larger fittings without bending under the strain required to swage these larger fitting. Finally, device 100 may be fully disassembled to allow individual components of device 100 to be replaced in the field.

Device 100 includes, two truss rods 9 connected to a base 6, a first die collar 12 removably secured to the distal ends of the truss rods 9, a second die collar 11 slideably retained by the truss rods 9, and a hydraulic cylinder 8 disposed on the base 6 and configured to forcibly drive the second die collar 11 towards the first die collar 12.

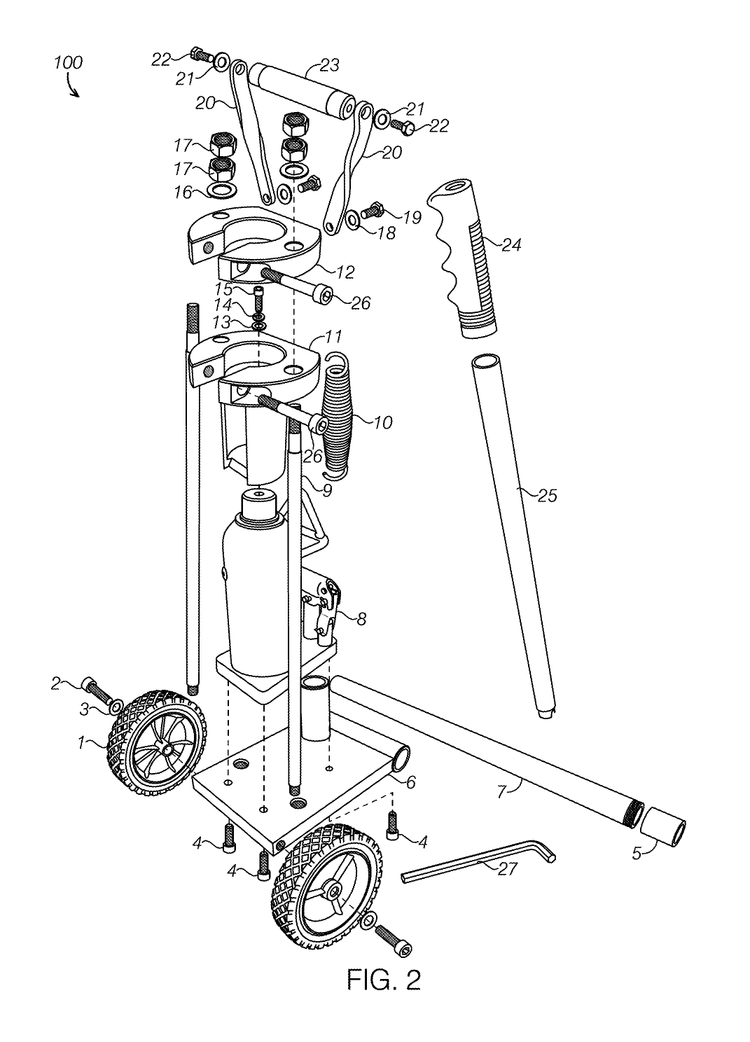

As can be seen in the exploded view of FIG. 2, each truss rod 9 includes a proximal end and a distal end. The truss rods 9 may have a circular cross section. The proximal end of each truss rod 9 is configured to be attached to the base 6. In one embodiment, the proximal end may include male threads and the base 6 may include a complimentary hole having female threads to receive the male threads. In some embodiments, each truss rod 9 may include a pair of opposing flat regions. These opposing flat regions may allow the truss rod 9 to be mechanically gripped to allow the truss rod to be securely screwed into the base 6. In other embodiments, the proximal end of each truss rod 9 may be secured to base 6 via other mechanisms.

The distal end of each truss rod 9 is configured to removably secure the first die collar 12 in place. In one embodiment, the distal end may include a stepped shoulder located below the male threads. The truss rod 9 may have a larger diameter beneath the stepped shoulder as compared to the diameter of the truss rod 9 above the stepped shoulder. In this embodiment, the first die collar 12 may include two circular holes configured to receive the truss rods 9. The holes may be sized to allow the smaller diameter of the truss rod 9 above the shoulder to pass through, while preventing the larger diameter beneath the shoulder from passing through. The first die collar 12 may thus be secured on one side by the stepped shoulder and on the other side by one or more threaded fasteners 17 threaded onto the distal end of the truss rod. In some embodiments, a washer 16 may be sandwiched between the threaded fastener(s) 17 and the first die collar 12.

In some embodiments, the first die collar 12 is supported entirely by the truss rods. Thus, device 100 may be free of any additional vertical support members aside from the truss rods 9. For example device 100 may be free of any external framework. It has been found that an external framework may impart eccentric forces into the truss rods when the die collars are compressed together (via the hydraulic cylinder 8, for example). Eccentric forces exerted on the truss rods 9 have been found to cause binding of the second die collar 11 as it travels along the truss rods 9. In this regard, device 100 may be capable of swaging larger diameter pipe fittings, which require larger compressive forces, without binding of the second die collar 11. Furthermore the truss rods 9

The second die collar 11 may be slideably retained by the truss rods 9, between the base 6 and the first die collar 12. In one embodiment, the second die collar 11 may be retained by the truss rods 9 via circular holes in the second die collar 11.

The hydraulic cylinder 8 may be removably secured to the base 6, between the truss rods 9. In one embodiment, the hydraulic cylinder 8 may be secured to the base 6 via threaded fasteners 4 inserted from below the base 6. The hydraulic cylinder 8 may be disposed such that it is operable to forcibly drive the second die collar 11 upwards, along the truss rods 9, toward the first die collar 12.

As can be seen in FIG. 2, the first die collar 12 may comprise a collar-shaped upper member. The collar-shaped upper member may include a circular inner bore and an opening at the front edge. A fastening member 26 may span the opening such that tightening the fastening member may cause the inner bore to constrict. In one embodiment, fastening member 26 may be a threaded bolt. In some embodiments, the collar shaped upper member may include a hole on each edge of the opening. In some embodiments, one of the holes may have female threads to engage with the male threads of the threaded bolt.

Second die collar 11 may comprise a collar-shaped upper member (similar or identical to the collar-shaped member of the first die collar 12) in addition to a hollow, frustoconical-shaped lower member. The collar-shaped upper member may include a circular inner bore and an opening at the front edge. A fastening member 26 may span the opening such that tightening the fastening member may cause the inner bore to constrict. In one embodiment, fastening member 26 may be a threaded bolt. In some embodiments, the collar shaped upper member may include a hole on each edge of the opening. In some embodiments, one of the holes may have female threads to engage with the male threads of the threaded bolt.

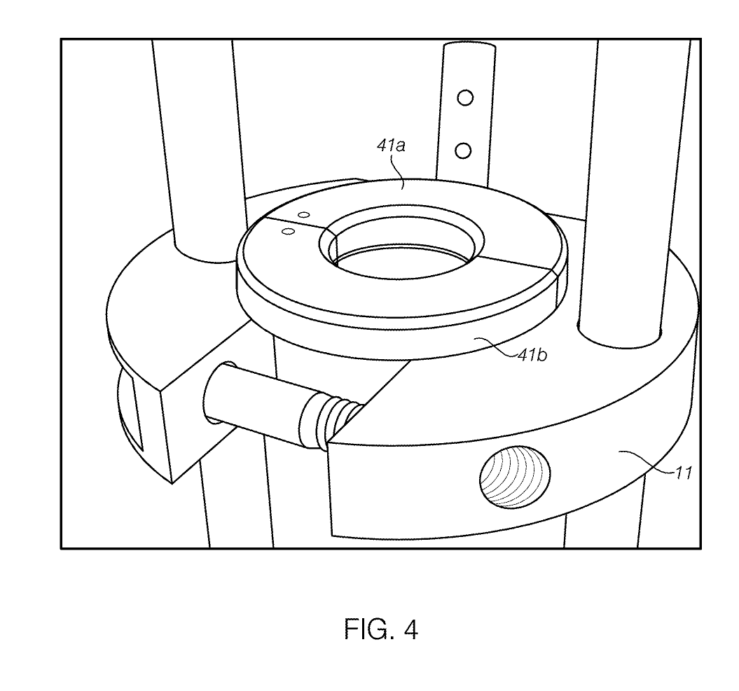

As can be seen in FIG. 4, second die collar 11 may support a swaging die, for example a two-part swaging die 41a, 41b. As can be seen, two-part swaging die 41a, 41b includes a tapered inner bore and an outer flange. The tapered inner bore functions to swage hose fittings into secure connection onto flexible hose. The outer flange functions to hold the die in place. Tightening fastening member 26 may cause the collar member of the second die collar 11 to constrict, thus gripping the die. First die collar 12 may grip a second swaging die in a similar fashion. In some embodiments, grip 24 may house an Allen wrench 27 for tightening fastening member 26.

The base of the frustoconical-shaped lower member of the second die collar 11 may be attached (e.g., welded) below the collar-shaped upper member such that the frustoconical-shaped lower member extends downward toward the hydraulic cylinder 8 such that the lower surface of the frustoconical-shaped lower member contacts the piston of the hydraulic cylinder 8. A threaded fastening member 15 may connect the lower surface of the frustoconical-shaped lower member to the piston. In some embodiments, one or more washers 13, 14, may be disposed between the head of fastening member 15 and the frustoconical-shaped lower member.

The frustoconical-shaped lower member may have an open channel formed in the sidewall. The open channel may line up with the opening at the front edge of the collar-shaped member. In this regard, a length of hose and/or a hose fitting may extend into the hollow lower member and be visible and accessible via the open channel.

The hydraulic cylinder 8 is manually operable via a removable lever arm 25. Lever arm 25 may comprise a grip 24. Lever arm 25 may be inserted into a pivoting sleeve of the hydraulic cylinder 8 and lever arm 25 may be manually actuated up and down. In this manner the pressure in the hydraulic cylinder 8 may be increased. In this manner the piston of the hydraulic cylinder 8 may be forced upward, thereby driving the second die collar 11 toward the first 12. Thus in operation, the appropriate swaging die(s) and hose ends and swagable hose fittings may be placed in device 100, the hydraulic cylinder 8 may be actuated, via lever arm 25, and the hose fittings may be securely attached to the hose ends.

The hydraulic cylinder may further include a pressure relief valve to allow the piston to retract. As shown in FIGS. 1 and 2, base 6 may include a retaining sleeve to store the removable lever arm 25 when device 100 is being transported.

In some embodiments, the hydraulic cylinder 8 may comprise a bottle jack. In other embodiments, the hydraulic cylinder may comprise another type of manually actuated hydraulically driven piston.

In some embodiments, device 100 may include a stabilizing leg 7. Stabilizing leg 7 may function to stabilize device 100 during operation of the device. For example stabilizing leg 7 may comprise a detachable elongate member. In operation, the elongate member may be inserted into a tube on base 6, wherein the tube is configured to receive and snugly grip the elongate member. Thus, the elongate member may function to increase the effective foot print of device 100. In this regard, stabilizing leg 7 may be configured to prevent device 100 from tipping over during operation. Stabilizing leg may further include a cap 5 on the distal end of the elongate member.

Device 100 may include a removable handle 23. Handle 23 may facilitate transporting device 100. Handle 23 be attached to the first die collar 11 via a pair of arms 20. Handle 23 may attach to the arms 20 via threaded fastening members 22 and optionally washers 21. Similarly, arms 20 may attach to the first die collar 11 via threaded fastening members 19 and optionally washers 18.

In some embodiments, device 100 may include a spring 10. Spring 10 have two ends, one end begin attached to the second die collar 11 and the other end being attached to hydraulic cylinder 8. The spring 10 may function to provide a retracing force to the piston of hydraulic cylinder 8.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A hose fitting swaging device comprising:
a base;
at least two truss rods spaced apart from each other and extending upward from the base, each truss rod having a proximal end removably secured to the base and distal end above the base;
a first die collar removably secured to the distal ends of the truss rods;
a second die collar slideably retained by the truss rods, between the base and the first die collar; and
a hydraulic cylinder removably secured to the base in between the truss rods and beneath the second die collar such that the hydraulic cylinder is operable to forcibly drive the second die collar upwards, along the truss rods, toward the first die collar;
wherein the first die collar is supported entirely by the truss rods.

2. The hose fitting swaging device of claim 1, wherein the truss rods have a circular cross section.

3. The hose fitting swaging device of claim 1, wherein the first die collar includes two circular holes configured to receive the truss rods; and wherein the second die collar includes two circular holes configured to receive the truss rods.

4. The hose fitting swaging device of claim 3, wherein the distal end of each truss rod includes a stepped shoulder and a threaded end.

5. The hose fitting swaging device of claim 4, wherein the first die collar is retained at the distal end of each truss rod between the stepped shoulder and a nut secured onto the threaded end.

6. The hose fitting swaging device of claim 1, wherein each truss rod includes a pair of opposing flat regions.

7. The hose fitting swaging device of claim 1, comprising a stabilizing leg secured to the base, wherein the stabilizing leg is configured to prevent the hose fitting swaging device from tipping over during operation.

8. The hose fitting swaging device of claim 6, wherein the stabilizing leg comprises a detachable elongate member, and wherein the base comprises a tube configured to receive the elongate member.

9. The hose fitting swaging device of claim 1 comprising a detachable lever arm configured to assist in pressurizing the hydraulic cylinder.

10. The hose fitting swaging device of claim of claim 1, comprising a spring having two ends, one end being attached to the second die collar and the other end being attached to the hydraulic cylinder.

11. A hose fitting swaging device comprising:
a base;
at least two truss rods spaced apart from each other and extending upward from the base, each truss rod having a proximal end removably secured to the base and distal end above the base;
a first die collar removably secured to the distal ends of the truss rods;
a second die collar slideably retained by the truss rods, between the base and the first die collar; and
a hydraulic cylinder removably secured to the base in between the truss rods and beneath the second die collar such that the hydraulic cylinder is operable to forcibly drive the second die collar upwards, along the truss rods, toward the first die collar;
wherein the hose fitting swaging device is free of vertical support members aside from the truss rods.

12. The hose fitting swaging device of claim 11, wherein the truss rods have a circular cross section.

13. The hose fitting swaging device of claim 11, wherein the first die collar includes two circular holes configured to receive the truss rods; and wherein the second die collar includes two circular holes configured to receive the truss rods.

14. The hose fitting swaging device of claim 13, wherein the distal end of each truss rod includes a stepped shoulder and a threaded end.

15. The hose fitting swaging device of claim 14, wherein the first die collar is retained at the distal end of each truss rod between the stepped shoulder and a nut secured onto the threaded end.

16. The hose fitting swaging device of claim 11, comprising a stabilizing leg inserted into the base, wherein the stabilizing leg is configured to prevent the hose fitting swaging device from tipping over during operation.

17. The hose fitting swaging device of claim 16, wherein the stabilizing leg comprises a detachable elongate member, and wherein the base comprises a tube configured to receive the elongate member.

18. The hose fitting swaging device of claim 1 comprising a detachable lever arm configured to assist in pressurizing the hydraulic cylinder.

19. The hose fitting swaging device of claim 18, wherein the base comprises a storage sleeve for the detachable lever arm.

20. A hose fitting swaging device comprising:
a base;
at least two truss rods spaced apart from each other and extending upward from the base, each truss rod having a proximal end removably secured to the base and distal end above the base;
a first die collar removably secured to the distal ends of the truss rods;
a second die collar slideably retained by the truss rods, between the base and the first die collar;
a hydraulic cylinder removably secured to the base in between the truss rods and beneath the second die collar such that the hydraulic cylinder is operable to forcibly drive the second die collar upwards, along the truss rods, toward the first die collar; and
a stabilizing leg secured to the base, wherein the stabilizing leg is configured to prevent the hose fitting swaging device from tipping over during operation;
wherein the first die collar is supported entirely by the truss rods.
